(19) United States
(12) Patent Application Publication
(10) Pub. No.: US 2016/0346812 A1
(43) Pub. Date: Dec. 1, 2016

(54) DUST-CLEANING STRUCTURE AND ELECTRONIC SYSTEM USING SAME

(71) Applicant: HON HAI PRECISION INDUSTRY CO., LTD., New Taipei (TW)

(72) Inventors: MING-CHIH SUN, New Taipei (TW); HSIEH-TUNG CHUNG, New Taipei (TW); KUN-CHENG CHEN, New Taipei (TW)

(21) Appl. No.: 14/788,332

(22) Filed: Jun. 30, 2015

(30) Foreign Application Priority Data
May 26, 2015 (TW) 104116891

(51) Int. Cl. B08B 5/02

(52) U.S. Cl. CPC B08B 5/02

(57) ABSTRACT

The present disclosure relates to a dust-cleaning structure, the dust-cleaning structure includes a first strainer, at least one fan, a vibrating motor and a controller. The at least one fan is assigned at a side of the first strainer and can be rotated a first direction and a second direction. The vibrating motor is connected to the first strainer. The controller is used to control the fan. The present disclosure also relates to an electronic system using the dust-cleaning structure.

### FIELD

The subject matter herein generally relates to a dust-cleaning structure and an electronic system using same.

### BACKGROUND

Electronic systems are growing in popularity and can be found in environments that are not favorable to operation of the electronic device. For example, electronic devices have been configured to be used in workshops and outdoors. However, these electronic devices suffer from the accumulation of dust which prevents heat dissipation from being effective. A traditional system to prevent dust buildup includes a strainer and a fan. The fan can be used to blow particles off of the strainer.

### BRIEF DESCRIPTION OF THE DRAWINGS

Implementations of the present technology will now be described, by way of example only, with reference to the attached figures.

FIG. 1 is a diagrammatic view of a dust-cleaning structure according to a first embodiment of the disclosure.

FIG. 2 is a diagrammatic view of an electronic system according to a second embodiment of the disclosure.

FIG. 3 is a diagrammatic view of a dust-cleaning structure according to a third embodiment of the disclosure.

FIG. 4 is a diagrammatic view of an electronic system according to a fourth embodiment of the disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The term “comprising,” when utilized, means “including, but not necessarily limited to”; it specifically indicates open-ended inclusion or membership in the so-described combination, group, series and the like.

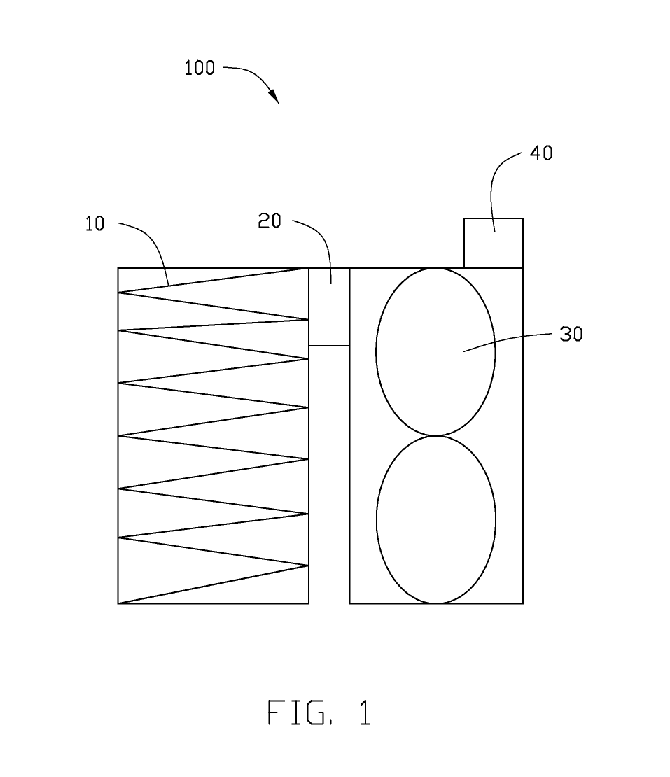

FIG. 1 illustrate a first embodiment of a dust-cleaning structure 100 of the present disclosure, the dust-cleaning structure 100 includes a first strainer 10, a vibrating motor 20, two fans 30 and a controller 40.

The first strainer 10 is used to filter dust from air that is flowing into the fan 30. In the illustrated embodiment, the first strainer 10 is a polypropylene mesh. In other embodiments, the first strainer 10 can be other filters, such as static mesh and foam type mesh. The size and porosity of the filter can be selected based on the application. The vibrating motor 20 is connected to the first strainer 10 and is used to make the dust attached on the first strainer 10 loose. The fans 30 are set at a side of the first strainer 10. In the illustrated embodiment, the fans 30 can be rotated a first direction and a second direction. For example, the fans 30 can be rotated clockwise and counterclockwise. While the direction of the fan blades is described as clockwise and counterclockwise, the directions can be any pair of directions that are opposite to one another. The use of clockwise and counterclockwise is for ease of description and the remainder of the disclosure is described as such. The fans 30 are used to blow away the dust attached on the first strainer 10. In the illustrated embodiment, the two fans 30 and the first strainer 10 are spaced from each other by a predetermined distance.

In the illustrated embodiment, the vibrating motor 20 is located at a position between the two fans 30 and the first strainer 10. It is understood that the vibrating motor 20 can be located at a side of the first strainer 10 away from the fan 30. The controller 40 is connected to the fans 30, and the controller 40 is used to control the fans 30.

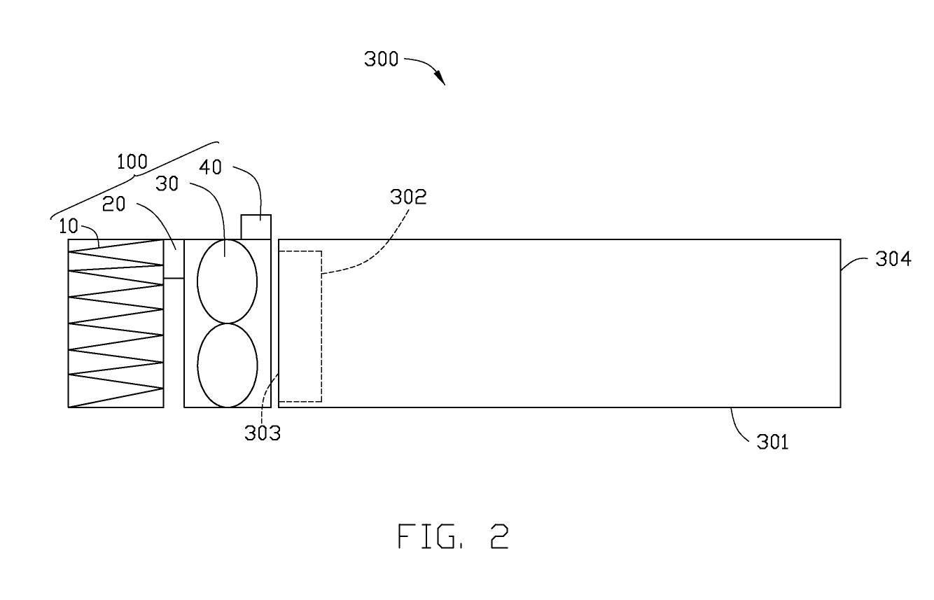

FIG. 2 illustrate a second embodiment of an electronic system 300 of the present disclosure, the electronic system 300 includes a basal body 301 and the dust-cleaning structure 100. A system fan 302 is arranged in the basal body 301, the system fan 302 is configured to cool the electronic system 300. The basal body 301 defines an air inlet 303 and an air outlet 304, the air inlet 303 and the air outlet 304 are respectively located in two opposite ends of the basal body 301. The dust-cleaning structure 100 is adjacent to the air inlet 303 of the basal body 301.

In operation, the first strainer 10 filters dust in air flowing into the electronic system 300. The fans 30 and the system fan 302 both rotates in a clockwise direction so that air is first filtered by the first strainer 10 as air flows into the basal body 301 from the air inlet 303. Then, the air flows through the basal body 301 and flows out of the electronic system 300 from the air outlet 304. Heat produced by the electronic system 300 is transferred to the air as it flows past the electronic system 300. When the electronic system 300 stops operation, the system fan 302 stops rotating. The controller 40 can control the fans 30 to rotate counterclockwise, thereby the fans 30 direct the air away from the basal body 301; the vibrating motor 20 vibrates the first strainer 10 to loosen the dust attached on the first strainer 10, and the dust that is shaken from the first strainer 10 is blown away by the fans 30.

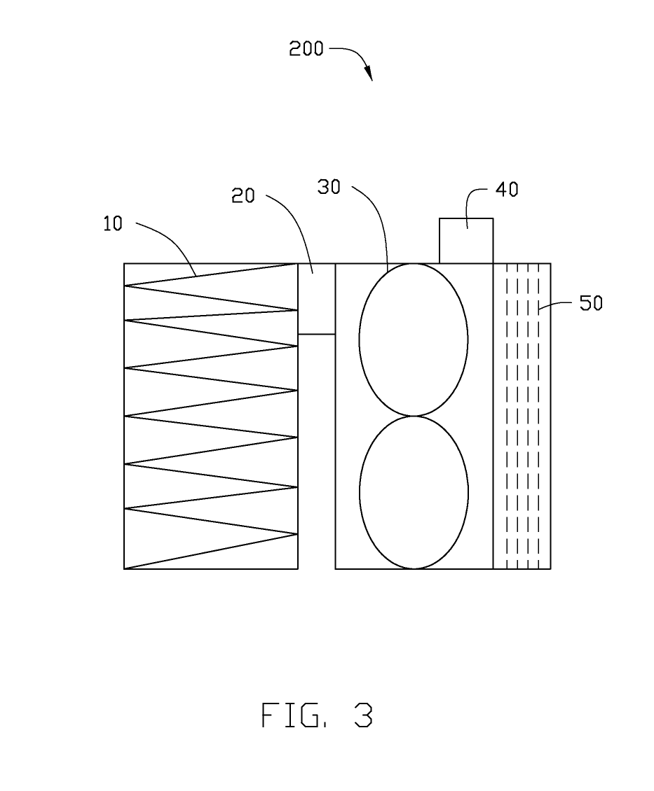

FIG. 3 illustrates a third embodiment of a dust-cleaning structure 200 of the present disclosure, the dust-cleaning structure 200 is similar to the dust-cleaning structure 100, except that the dust-cleaning structure 200 further includes a second strainer 50. The second strainer 50 is set at a side of the fans 30 away from the first strainer 10, and is used to filter the dust. In the illustrated embodiment, grid density of the second strainer 50 is greater than grid density of the first strainer 10.

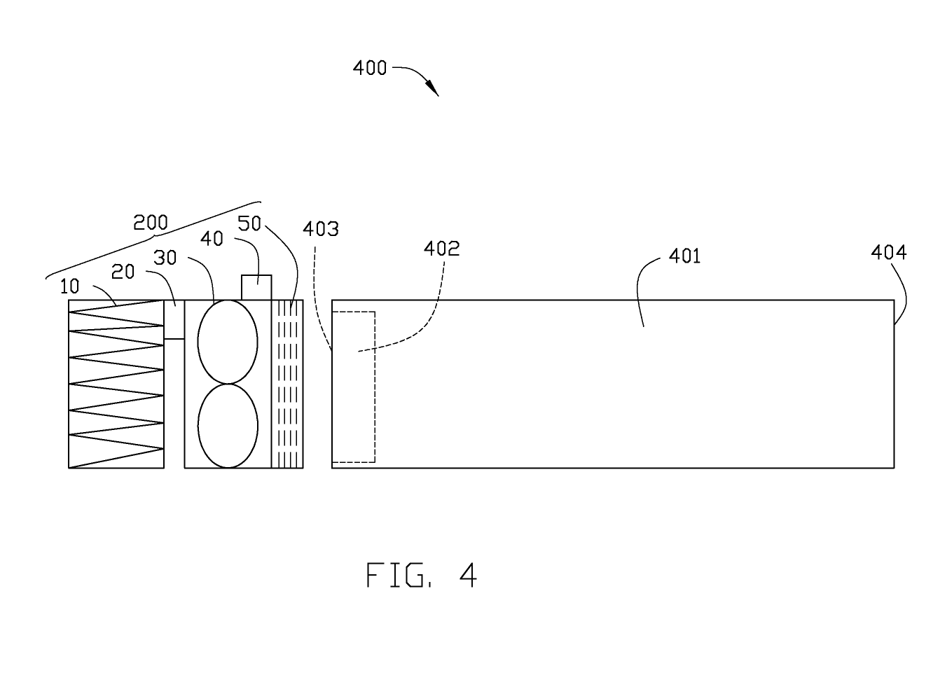

FIG. 4 illustrates a fourth embodiment of an electronic system 400 of the present disclosure, the electronic system 400 comprises a basal body 401 and a dust-cleaning structure 200. A system fan 402 is arranged in the basal body 401, the system fan 402 is configured to cool the electronic system 400. The basal body 401 defines an air inlet 403 and an air outlet 404, the air inlet 403 and the air outlet 404 are respectively located in two opposite ends of the basal body 401. The dust-cleaning structure 200 is arranged adjacent to the air inlet 403 of the basal body 401.

In operation, the first strainer 10 filters dust in air flowing into the electronic system 400. The fans 30 and the system fan 402 both rotates in a clockwise direction so that air is first filtered by the first strainer 10 and the second strainer 50 as air flows into the basal body 401 from the air inlet 403. Then, the air flows through the basal body 401 and flows out of the electronic system 400 from the air outlet 404. Heat produced by the electronic system 400 is transferred to the air as it flows past the electronic system 400. When the electronic system 400 stops operation, the system fans 402 stop rotating. The controller 40 can control the fans 30 to rotate counterclockwise, thereby the fans 30 direct the air away from the basal body 401; the vibrating motor 20 vibrates the first strainer 10 to loosen the dust attached on the first strainer 10, and the dust that is shaken from the first strainer 10 is blown away by the fans 30.

The embodiments shown and described above are only examples. Many details are often found in the art such as the other features of a dust-cleaning structure. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A dust-cleaning structure comprising:
a first strainer;
at least one fan arranged at side of the first strainer, and the at least one fan being able to rotate in a first direction and a second direction opposite to the first direction;
a vibrating motor connected to the first strainer; and
a controller configured to control the operation of the at least one fan, the controller controlling the at least one fan to rotate in the first direction or the second direction.

2. The dust-cleaning structure of claim 1, wherein the vibrating motor is located at a position between the first strainer and the at least one fan.

3. The dust-cleaning structure of claim 1, wherein the dust-cleaning structure further comprises a second strainer, the second strainer is set at a side of the fans away from the first strainer.

4. The dust-cleaning structure of claim 3, wherein grid density of the second strainer is greater than grid density of the first strainer.

5. An electronic system comprising:
a basal body defining an air inlet; and
a dust-cleaning structure arranged adjacent to the air inlet, and comprising:
a first strainer;
at least one fan arranged at side of the first strainer, and the at least one fan can be rotated a first direction and a second direction;
a vibrating motor connected to the first strainer; and
a controller configured to control the operation of the at least one fan, the controller controlling the at least one fan to rotate in the first direction or the second direction.

6. The electronic system of claim 5, wherein the electronic system comprises a system fan, the system fan is used to cool the electronic system.

7. The electronic system of claim 5, wherein the vibrating motor is located at a position between the first strainer and the at least one fan.

8. The electronic system of claim 5, wherein the dust-cleaning structure further comprises a second strainer, the second strainer is set at a side of the fans away from the first strainer.

9. The electronic system of claim 8, wherein wherein grid density of the second strainer is greater than grid density of the first strainer.
